(19) United States
(12) Patent Application Publication
(10) Pub. No.: US 2022/0385641 A1
(43) Pub. Date: Dec. 1, 2022

(54) SECURE COMMUNICATION METHOD

(71) Applicant: AIRBUS CYBERSECURITY SAS, ELANCOURT (FR)

(72) Inventors: Nicolas PABST, ELANCOURT (FR); Paul-Emmanuel BRUN, ELANCOURT (FR); Paul-Emmanuel VANDENBURIE, ELANCOURT (FR)

(21) Appl. No.: 17/775,827

(22) PCT Filed: Nov. 12, 2020
(86) PCT No.: PCT/EP2020/081969

§ 371 Date: May 10, 2022

(30) Foreign Application Priority Data
Nov. 12, 2019 (FR) FR1912624

(51) Int. Cl. H04L 9/40

(52) U.S. Cl. CPC H04L 63/0428; H04L 63/102

(57) ABSTRACT

A method for secure communication between a connected object and an entity, includes, for each access to each encrypted key in the memory of the connected object, a preliminary procedure of determining, by each connected object, an access key to its encrypted memory, from at least one fingerprint of a determined memory area and/or hardware of the connected object, and wherein the connected object performs, for each sending or receipt of an encrypted message during a communication with the entity: determining, by the connected object, the access key to its encrypted memory, accessing, in the memory of the connected object, a symmetric encrypted key suitable for encrypted exchanges between the connected object and the entity, symmetric encrypting of the message to be sent to the entity or of symmetric decrypting of the message received from the entity.

### TECHNICAL FIELD OF THE INVENTION

The technical field of the invention is that of secure communication methods within networks and particularly within networks comprising connected objects also referred to as loTs.

### TECHNOLOGICAL BACKGROUND OF THE INVENTION

The use of connected objects is growing rapidly because they can be particularly interesting in the observation of physical quantities using sensors, for example in industry where production process supervision is set up. Another example of this field is home automation or connected vehicles.

It is important to guarantee information security as much as possible, by reinforcing the privacy, integrity, availability and traceability of the data exchanged over these networks for economic, strategic or security reasons.

U.S. Pat. No. 7,533,422 is known, which describes the sending of a self-executing file comprising data encrypted using a key that may be specific to each transmitted file. However, the encryption key used is also included in encrypted form in the transmitted file, which increases the risk of access or corruption in the event of the message being intercepted. Moreover, if the device receiving the file is accessed, access to the locally stored password allows the received file to be decrypted.

There is thus a need to reinforce the security of information exchanged over networks comprising loTs by providing a communication method whose security level is reinforced while also allowing the use of symmetric secret key encryption in order to save energy-limited loT resources.

### SUMMARY OF THE INVENTION

The invention provides a solution to the previously mentioned problems by reinforcing the security of information exchanged over networks comprising loTs while allowing symmetric secret key encryption.

One aspect of the invention concerns a method for secure communication between at least one connected object and at least one entity in at least one communication network, said secure communication method being characterized in that it comprises, for each access to each encrypted key in memory of said connected object a prior step of determining, by each connected object, an access key to its encrypted memory, from at least one fingerprint of a determined memory area and/or a hardware fingerprint of the connected object, and in that the connected object performs, for each sending or receipt of an encrypted message during a communication with said entity:
a step of determining, by said connected object, the access key to its encrypted memory,
a step of accessing, in the memory of the connected object, a symmetric encrypted key specific to the encrypted exchanges between the connected object and said entity,
a step of symmetrically encrypting the message to be sent to said entity or of symmetrically decrypting the message received from said entity.

In addition to the characteristics just mentioned in the preceding paragraph, the secure communication method according to one aspect of the invention may have one or more additional characteristics from among the following, considered individually or according to all technically possible combinations:
said connected object is in communication with a plurality of entities in said communication network including a managing entity and at least one processing entity, the method comprising steps prior to encrypted communications between the connected object and said processing entity:
   a step of sending, by said connected object, to the managing entity, a request for generating a key specific to the encrypted exchanges between the connected object and said processing entity, comprising at least one identifier of the connected object and a timestamp of the request for generating a key,
   a step of generating, by the managing entity, the symmetric key specific to the encrypted exchanges between said connected object and said processing entity, by deriving the identifier of the connected object, a timestamp depending on the timestamp of the request for generating a key and a secret specific to said processing entity,
   a step of storing, by at least said processing entity, the timestamp depending on the timestamp of the request for generating a key, associated with the identifier of the connected object and with the secret specific to said processing entity,
   a step of transmitting, by the managing entity, to the connected object, the key specific to the encrypted exchanges between the connected object and said processing entity,
   a step of determining, by the connected object, the access key to its encrypted memory,
   a step of encrypting, by the connected object, the received key, using the access key to the encrypted memory and of storing, in encrypted form, the received key.
the timestamp depending on the timestamp of the generation request and is calculated from the timestamp of the generation request and a time offset corresponding to the receipt of this request.
the timestamp of the generation request corresponds to a corrected timestamp.
for receiving or sending an encrypted content, between said processing entity and said connected object, said processing entity carries out:
   a step of generating the key specific to the encrypted exchanges between the connected object and said processing entity by deriving at least the secret specific to said processing entity, the identifier of the connected object and the timestamp associated in memory with the identifier of the connected object and with the secret specific to said processing entity,
   a step of symmetrically decrypting the received encrypted content or of symmetrically encrypting the content to be sent, using the key specific to the encrypted exchanges between the connected object and said processing entity.
the request for generating a key specific to the encrypted exchanges between the connected object and said processing entity, sent to the managing entity, and the transmission of this key, by the managing entity, to the connected object, are encrypted using a symmetric key specific to the exchanges between the managing entity and said connected object, the method comprising beforehand:
   a step of generating, by the managing entity, the symmetric key specific to the encrypted exchanges between the connected object and the managing entity, by deriving at least one secret specific to the managing entity using the identifier of the connected object,
   a step of supplying, by the managing entity, to the connected object, the key specific to the encrypted exchanges between the connected object and the managing entity,
   a step of determining, by the connected object, the access key to its encrypted memory,
   a step of encrypting, by the connected object, the supplied key, using the access key to its encrypted memory and of storing the supplied key in encrypted form.

By virtue of the invention, the communication key(s), stored in encrypted form by each connected object, allow authentication of each connected object, capable of decrypting a received message, while providing each connected object with protection to guarantee its integrity. This is to prevent software or hardware modifications that would render a modified object inoperable over the network.

The communication key(s), stored in encrypted form by the connected object, are on the one hand specific to the connected object and on the other hand can only be decrypted by this connected object. The fingerprint can thus avoid transiting through the network.

Advantageously, by instantiating an enrolment by the managing entity resulting in a key for communication with the managing entity followed by one or more enrolments encrypted by one or more processing entities, the result is the secure transmission of keys, specific to each connected object, for communication with the processing entities. These communication keys are exchanged in encrypted form and stored in encrypted form. The installation in a communication network of connected objects communicating securely with processing entities is thus particularly simplified and secure. The classic problems of transmitting and storing secrets and of stealing fingerprints by intercepting exchanges within the network are thus overcome. The fingerprint is never transmitted outside the connected object.

Advantageously, the systematic determination of the access key to the encrypted memory with a view to encrypting or decrypting a message guarantees a certain hardware and software integrity of the connected object, throughout its operation via the network.

Another aspect of the invention relates to a computer program comprising program code instructions for carrying out the steps of the method according to the invention when said program is executed on a computer.

The invention and its various applications will be better understood upon reading the following description and examining the accompanying figures given as examples.

### BRIEF DESCRIPTION OF THE FIGURES

The figures are set forth by way of illustrating and in no way limiting purposes of the invention.

FIG. 1 shows a schematic representation of a communication network for implementing an example of a method according to the invention.

FIG. 2 schematically represents an example of a secure communication method according to the invention.

FIG. 3 shows in a schematic representation of an example of generation of an access key to its encrypted memory by a connected object.

### DETAILED DESCRIPTION

The figures are set forth by way of indicating and in no way limiting purposes of the invention.

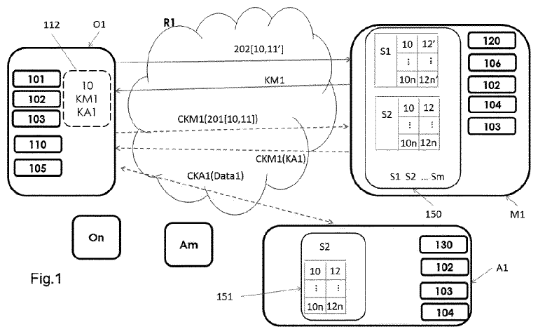

Unless otherwise specified, the same element appearing in different figures has a unique reference.

[FIG. 1] FIG. 1 shows a schematic representation of a communication network for implementing a method according to the invention.

As represented in FIG. 1, the communication network R1 comprises connected objects O1 to ON, a managing entity M1 and processing entities A1 to AM. The number of connected objects, managing entities and processing entities in the communication network is not limitative and can even change especially by virtue of the installation facilities provided.

Each managing entity Ml, processing entity A1 to AM and connected object O1 to ON comprises, for example, a calculation component, a memory and a network interface and communication module 103. The network may be the Internet, an intranet, a wired or wireless network such as Wi-Fi or a 2G, 3G, 4G or 5G cellular network. Several types of networks can be combined, the security of the information is advantageously not linked to the structure of the network(s) through which the information transits.

Connected objects can have different roles, such as monitoring physical parameters such as temperature or pressure, executing commands or providing information to electronic devices. A connected object can thus be used for home automation such as a connected light bulb, a connected lock or a connected thermostat. A connected object can also take the form of a connected camera, a connected watch, a connected scale, a GPS (Global Positioning System) satellite tracker or a vehicle or drone.

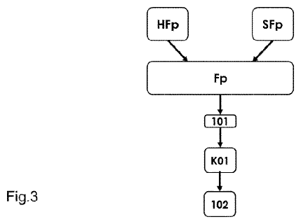

The connected object O1 comprises a management module 110 especially for carrying out the steps successively described in the present description. The connected object comprises a symmetric encryption and decryption module 102. This module 102 will be executed, for example, to decrypt or encrypt a message during a communication with a network entity. This module 102 is also executed in combination with a module 101 for determining an access key KO1 to the encrypted memory 112 of the connected object. A key KM1 for communication with the managing entity M1 and a key KA1 for communication with the processing entity Al are stored in encrypted form. Other keys for communication with other entities may also be stored in encrypted form. Each key for communication with the network entities KM1 and KA1 is specific to the connected object O1. The identifier 10 of the connected object O1 can also be stored in encrypted form. The encryption key KO1 for the storage in memory of the connected object, which will be described in more detail in relation to FIG. 3, is also specific to the connected object O1. In addition, the connected object O1 also comprises a timestamp module 105. This timestamp module may comprise a timestamp correction function. This correction is implemented according to the dates of the exchanges with the network entities.

The managing entity M1 comprises a management module 120 especially for carrying out the steps successively described in the present description. The managing entity Also comprises a symmetric encryption and decryption module 102. The keys used for sending encrypted communications are calculated by a key generation module 104. The keys are especially generated from a secret S1, S2 or SM stored in memory 150 and depending on the identifier 10 to 10N of the connected object with which the secure communication is established.

The timestamp may also be used for key generation. A timestamp adjustment module 106 generates an adjusted timestamp 12 or 12′ from a received timestamp 11 or 11′, for example by subtracting therefrom the time offset corresponding to the transmission time or corresponding to an adjustment with respect to an external universal clock.

Each identifier 10 to 10N is thus stored in association with its possibly adjusted request timestamp 12′ to 12N′ and in association with the secret S1, used for encrypted communications between each connected object and the managing entity M1.

Each identifier 10 to 10N is further stored in association with its possibly adjusted request timestamp 12 to 12N and in association with the secret S2 used for encrypted communications between each connected object and the processing entity A1.

The key generation program 104 may, for example, be in the form of a secret derivation protocol such as NIST-800-108-KDF, X9.63-KDF, NIST-800-56-KDF-A/B, NIST-800-56-KDF-C or HKDF.

The processing entity A1 comprises a management module 130 especially for carrying out the steps successively described in the present description. The processing entity A1 comprises a symmetric encryption and decryption module 102 using keys supplied by its key generation module 104. The processing entity Al stores the secret S2 used for encrypted communications with each connected object. The keys are generated from this stored secret S2 and for each connected object, from its identifier 10 to 10N. Each identifier 10 to 1ON is associated in memory 151 with a timestamp 12 to 12N, in the same way as in the managing entity.

The processing entity performs, for example, various operations of processing, storage, operating or transmission of the data from the connected objects and transmits to them in return, for example configuration settings or commands, their communications being advantageously encrypted. Data sent back from the connected objects can thus easily be made accessible to one or more users via the processing entity.

The processing entity A1 may also allow the connected object O1 secure access via itself to a resource, such as an application, a database, a library, an access manager, an authentication manager or a log manager. The processing entity A1 may in particular take the form of a reverse proxy. The processing entity A1 may also take the form of a gateway.

In FIG. 1, the encrypted communications have been represented as dotted lines. The enrolment, by the managing entity, comprising a request for a communication key with the managing entity and the sending of this key KM1 in return to the connected object O1, is here carried out in cleartext via the network. In this case, the key KM1 and the identifier 10 circulate only once via the network, limiting the risks of interception.

It could also be contemplated an enrolment by the managing entity carried out in a closed and secure network, before installing the connected object in the network R1 for its operation. This first enrolment is, for example, carried out in a secure and controlled environment, such as in a factory, on a secure site with physical and logical access control, or on a partitioned Intranet network. The component can then be moved for its final operation, at the end of this enrolment phase.

In FIG. 1, the request 201 for a communication key with the processing entity A1 as well as the generated key KA1 are transmitted using an encryption CKM1 using the key KM1 specific to the communications between the managing entity M1 and the connected object O1.

The data Data1 exchanged between the connected object O1 and the processing entity A1 is transmitted using an encryption CKA1 using the key KA1 specific to the communications between the processing entity A1 and the connected object O1.

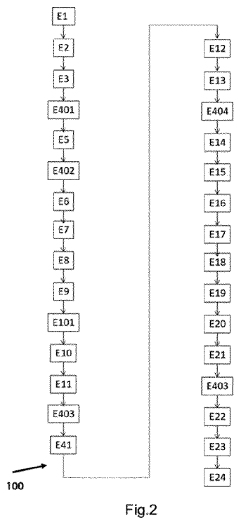

The operations aimed at securing the information will be further detailed below in different examples of secure communication steps according to the invention.

[FIG. 2] FIG. 2 schematically represents an example of a secure communication method according to the invention.

The connected object O1 transmits, for example, to the managing entity, in step E1, a request 202 for a communication key KM1 with the managing entity specific to the connected object O1. This request includes, for example, an identifier 10 of the connected object O1 and a timestamp 11′ of the request. The request is transmitted by the connected object O1, for example during a phase of enrolment of the connected object O1 by the managing entity M1. This request may also include a public key, stored by the connected object O1 with a private key and intended to encrypt the response of the managing entity.

Upon receipt of this request 202, the managing entity M1, in step E2, generates the symmetric encryption key KM1 specific to the communications between the managing entity M1 and the connected object O1. This generation is, for example, carried out by deriving the secret S1 known only to the managing entity M1 by using as a parameter the identifier 10 of the connected object O1.

A timestamp may also be used for the derivation. This timestamp is for example adjusted with respect to the transmission time, the adjusted timestamp 12′ being stored in memory in association with the identifier and the secret Sl. The time of receipt by the managing entity M1 is for example determined from the managing entity's internal clock or from an external universal time source. The time of transmission of the request is, for example, calculated with respect to a default transmission time to be then retransmitted to the connected object and allow it to adjust its internal clock.

The managing entity M1 then transmits, in step E3, the key KM1 to the connected object O1, in response to its request.

This key KM1 may be aggregated with the adjusted timestamp, allowing the connected object O1 to know the time offset between its internal clock and the universal time and thus create corrected timestamps. The connected object may, for example, subtract the received adjusted timestamp from the initial timestamp to calculate a correction offset of its internal clock.

The encryption key KM1 specific to communications between the managing entity M1 and the connected object O1 may be transmitted unencrypted. According to another embodiment, this key KM1 may also be encrypted before transmission, using a previously transmitted public key.

When the connected object O1 receives the encryption key KM1 specific to the communications between the managing entity M1 and the connected object O1, the connected object carries out, in step E401, a calculation of the read and write access key KO1 to its encrypted memory. The calculation of this key KO1 will be described in more detail in relation to FIG. 3.

The connected object O1 then performs, in step E5, an encryption of the key KM1 received using the access key KO1 to its encrypted memory and a storage, in encrypted form, of this encryption key KM1 specific to the communications between the managing entity M1 and the connected object O1. The encryption is performed by the symmetric encryption and decryption module 102.

Generally speaking, the encryption keys extracted or received by the connected object O1 in unencrypted form are erased or even overwritten after use.

The encryption key KM1 specific to the communications between the managing entity M1 and the connected object O1 is stored here exclusively in encrypted form in the connected object O1. In addition, this communication encryption key is encrypted by an access key to the encrypted memory, determined from software and hardware information providing a guarantee on the integrity and authenticity of the connected object O1.

If the connected object O1 were indeed physically affected and a part of its hardware were modified by a replacement or a connection or its software were tampered with, this attack would render the connected object inoperative over the network. This state would then be detected by the network entities. Indeed, the connected object O1 would then no longer be able to decipher the encryption keys enabling it to establish encrypted communications since the calculation of its access key to its encrypted memory would become erroneous.

The connected object O1 then prepares to send an encrypted message to the managing entity M1 and calculates, in step E402, its access key KO1 to its encrypted memory. This key calculation is performed, as previously, from at least one fingerprint SFp of a determined memory area of the connected object O1 and/or at least one hardware fingerprint HFp of the connected object O1. Thus, as previously explained, if its hardware or software configuration were tampered with, the connected object O1 could no longer communicate with the managing entity M1 via the encrypted communications.

The connected object then decrypts, in step E6, the key KM1 stored in memory in encrypted form for the establishment of an encrypted communication with the managing entity Ml.

Decryption is performed by executing the symmetric encryption and decryption module 102 using the access key KO1 to its encrypted memory.

Once the key KM1 for communication with the managing entity has been accessed, the connected object O1 performs, in step E7, the encryption CKM1 of a key request 201 for communication with the processing entity A1 and the transmission of this encrypted request CKM1(201) to the managing entity M1.

The request 201 is encrypted, according to a symmetric encryption, by the encryption module 102 of the connected object O1 using the key KM1 for communication with the managing entity Ml. The request includes, for example, the identifier 10 of the connected object O1 and a timestamp 11 of the request 201. The timestamp may for example be a corrected timestamp, taking the time difference between the two internal clocks of the connected object O1 and the managing entity M1 corresponding to universal time, into account.

Upon receipt of the encrypted request CKM1(201), the managing entity M1 performs, in step E8, a calculation of the encryption key KM1 used. The request includes the identifier 10 in cleartext, for the calculation by the key generation module 104 of a derivation of the secret S1 known to the managing entity using, for example, the received identifier 10 and the previously stored timestamp 12′.

After decryption, in step E9, the managing entity M1 may also check the validity of the request 201 by checking that the request has arrived within a validity interval according to the transmitted timestamp 11. This allows the managing entity

M1 to ensure that the request has not been subject to a “man-in-the-middle” attack, for example of the “replay” type, while taking the time offset of its internal clock with the internal clock of the connected object O1 into account.

The first key KM1 is regenerated by the managing entity M1 and used to decrypt the received encrypted request. An adjusted timestamp 12 is provided by the timestamp adjustment module 106 taking the transmission time, according to the received timestamp 11 into account.

The identifier 10 is stored, for example, by the managing entity and by the processing entity, in step E101, in association with the adjusted timestamp 12 and the secret S2 known to the processing entity. The communications between the processing entity and the managing entity, not represented, may be secured by various encryptions, depending on the application.

The managing entity M1 then executes, in step E10, the key generation module 104 from the secret S2 known to the processing entity A1 derived using the identifier 10 of the connected object and possibly the adjusted timestamp 12.

The key KA1 obtained for encrypting the communications between the connected object O1 and the processing entity A1, is then encrypted, using the symmetric key KM1 before being sent from the managing entity to the connected object O1, in step E11.

The key KA1 transmitted in response to the previous request 201, is thus encrypted by the encryption module 102, by symmetric encryption, using the key KM1 for encrypting the communications between the managing entity M1 and the connected object O1.

Upon receipt of the encrypted key CKM1(KA1), the connected object performs, in step E403, the calculation of its access key KO1 to its encrypted memory.

The connected object O1 can then access, in step E41, the key KM1 for encrypting communications with the managing entity M1, to decrypt the received message CKM1(KA1).

The connected object then decrypts the encrypted message coming from the managing entity, in step E12, to access the key KA1 for encrypting communications with the processing entity A1.

The connected object then performs, in step E13, an encryption of this last key KA1 using the access key KO1 to its encrypted memory for its storage, in encrypted form, in the memory of the connected object O1.

The access key KO1 to the encrypted memory, the key KA1 for communication with the processing entity and the key KM1 for communication with the managing entity, in their unencrypted form, are then erased from the memory of the connected object, or even overwritten.

The connected object then prepares, in step E404, an encrypted communication with the processing entity A1, by calculating the access key KO1 to its encrypted memory.

The calculation, by the connected object O1, of the access key to its encrypted memory is performed, as previously described, from at least one fingerprint of a determined memory area SFp of the connected object O1 and/or from at least one hardware fingerprint HFp of the connected object O1.

The connected object can then access, in step E14, the key KA1 allowing communication with the processing entity A1. This key KA1, stored in encrypted form, is decrypted using the access key KO1 to the encrypted memory by executing the symmetric decryption module 102.

Information Data1 to be transmitted to the processing entity A1 may then be encrypted, in step E141, by executing the encryption module 102 using the key KA1 for encrypting communications between the connected object O1 and the processing entity A1.

Generally speaking, after one use or even after a few uses, for example at the end of a step, the encryption keys, in unencrypted form, are systematically erased from the memory of the connected object or even overwritten.

The encrypted message CKA1(Data1) is then transmitted, in step E15, to the processing entity A1. In the diagram, CKA1(Data1) refers to all the encrypted messages, data or information that can be exchanged between the processing entity A1 and the connected object O1.

Upon receipt of the encrypted message from the connected object and comprising a cleartext identifier of this connected object O1, in step E16, the processing entity A1 carries out, for example, a memory search for this identifier 10 associated with an adjusted timestamp 12.

The processing entity may then execute, in step E17, the key generation module 104 by deriving the stored secret S2 using the received identifier 10 and for example using the stored timestamp 12. The key KA1, allowing the received message CKA1(Data1) to be decrypted, is then generated.

The processing entity then decrypts, in step E18, the received message by executing the decryption module 102 using the previously generated key KA1. The processing entity, in step A19, processes the message and generates the response message.

This response message is encrypted, in step E20, by executing the encryption module 102, using the encryption key KA1 specific to the exchanges between the connected object O1 and this processing entity A1.

After the encrypted response has been sent and received by the connected object, in step E21, the connected object performs a calculation of the access key KO1 to its encrypted memory, in step E405.

Once the access key KO1 to its encrypted memory has been generated, the connected object O1 may access, in step E22, the key KM1 specific to the exchanges between the connected object O1 and the processing entity A1.

The connected object can then decrypt, in step E23, the received message.

The received message can then be processed by the connected object O1 in step E24.

Encrypted exchanges between the connected objects and the processing entities may continue in the same manner.

A connected object can easily be added to the network by performing an enrolment by the managing entity directly with the managing entity and then an enrolment by the different processing entities with the managing entity.

A processing entity can also easily be added to the network by performing, for each connected object, an enrolment by this processing entity, with the managing entity.

This example thus illustrates the fact that the fingerprint used to calculate the access key to its encrypted memory is never communicated outside each connected object. It is also possible to transmit only in encrypted form the encryption key specific to the communications between each connected object and each processing entity, where this encryption provides a guarantee of the level of authenticity and integrity of the connected objects.

[FIG. 3] FIG. 3 shows in a schematic representation an example of generation of an access key to its encrypted memory by a connected object.

The module 101 for determining the access key to the encrypted memory determines, for example, a fingerprint Fp coming from the connected object. This fingerprint Fp is for example calculated from two fingerprints: a fingerprint SFp of a determined memory area of the connected object O1 and a hardware fingerprint HFp of the connected object O1.

The two fingerprints SFp and HFp are for example aggregated or combined to form the fingerprint Fp used by the module 101 for generating the access key KO1 to the encrypted memory. A fingerprint is for example calculated by a hash function.

From a hardware or software fingerprint or from a combination of hardware and software fingerprints, the module 101 for determining the access key to the encrypted memory generates an access key KO1 to the encrypted memory. This generation uses for example a hash function.

The access key KO1 to the encrypted memory is used by the encryption and decryption module 102 to perform read or write accesses to the encrypted memory.

Thus, in order to retrieve a key stored in encrypted form, the connected object O1 performs, for example, a collection of data of various components of the connected object O1, serial numbers of the components, status of registers representative of the state of the input and output ports, data stored in determined memory locations aggregated and then formatted, for example by a hash function such as SHA (“Secure Hash Algorithm”) or MD5 (“Message-Digest algorithm 5”). These hash functions make it possible to take a large number of data of different sizes and types and to create a signature of all these data having specific characteristics. In particular, a hash function allows a fixed size as an output. The components examined are, for example, sensors, processors or memories. For example, the serial number of a sensor is used. Other data relating to the hardware configuration of the connected object O1 that does not vary during a normal operating period can be taken into account. In particular, the intrusion of false connected objects is prevented.

A software fingerprint SFp can be used in particular to determine the access key to the encrypted memory and to check the integrity of the code on this occasion, if this portion of software does not vary during the normal operation period. In particular, malicious code replacement is prevented.

1. A method for secure communication between at least one connected object and at least one entity in at least one communication network, said secure communication method comprising, for each access to each encrypted key in memory of said connected object, a prior step of determining, by each connected object, an access key to its encrypted memory, from at least one fingerprint of a determined memory area and/or a hardware fingerprint of the connected object, and wherein the connected object performs, for each sending or receipt of an encrypted message during a communication with said entity,
a step of determining, by said connected object, the access key to its encrypted memory,
a step of accessing, in the memory of the connected object, a symmetric encrypted key specific to the encrypted exchanges between the connected object and said entity,
a step of symmetrically encrypting the message to be sent to said entity or of symmetrically decrypting the message received from said entity.

2. The method according to claim 1, said connected object is in communication with a plurality of entities in said communication network including a managing entity and at least one processing entity, the method comprising steps prior to the encrypted communications between the connected object and said processing entity:
a step of sending, by said connected object, to the managing entity, a request for generating a key specific to the encrypted exchanges between the connected object and said processing entity, comprising at least one identifier of the connected object and a timestamp of the request for generating a key,
a step of generating, by the managing entity, the symmetric key specific to the encrypted exchanges between said connected object and said processing entity, by deriving the identifier of the connected object, a timestamp depending on the timestamp of the request for generating a key and a secret specific to said processing entity,
a step of storing, by at least said processing entity, the timestamp depending on the timestamp of the request for generating a key, associated with the identifier of the connected object and with the secret specific to said processing entity,
a step of transmitting, by the managing entity, to the connected object, the key specific to the encrypted exchanges between the connected object and said processing entity,
a step of determining, by the connected object, the access key to its encrypted memory,
a step of encrypting, by the connected object, the received key, using the access key to the encrypted memory and of storing, in encrypted form, the received key.

3. The method according to claim 2, wherein the timestamp depending on the timestamp of the generation request is calculated from the timestamp of the generation request and a time offset corresponding to the receipt of this request.

4. The method according to claim 2, wherein the timestamp of the generation request corresponds to a corrected timestamp.

5. The method according to claim 2, wherein for receiving or sending an encrypted content, between said processing entity and said connected object, said processing entity carries out:
a step of generating the key specific to the encrypted exchanges between the connected object and said processing entity by deriving at least the secret specific to said processing entity, the identifier of the connected object and the timestamp associated in memory with the identifier of the connected object and with the secret specific to said processing entity,
a step of symmetrically decrypting the received encrypted content or of symmetrically encrypting the content to be sent, using the key specific to the encrypted exchanges between the connected object and said processing entity.

6. The method according to claim 2, wherein the request for generating the key specific to the encrypted exchanges between the connected object and said processing entity, sent to the managing entity, and the transmission of this key, by the managing entity, to the connected object, are encrypted using a symmetric key specific to the exchanges between the managing entity and said connected object, the method comprising beforehand:
a step of generating, by the managing entity, the symmetric key specific to the encrypted exchanges between the connected object and the managing entity, by deriving at least one secret specific to the managing entity using the identifier of the connected object,
a step of supplying, by the managing entity, to the connected object, the key specific to the encrypted exchanges between the connected object and the managing entity,
a step of determining, by the connected object, the access key to its encrypted memory,
a step of encrypting, by the connected object, the supplied key, using the access key to its encrypted memory and of storing the supplied key in encrypted form.

7. A non-transitory computer readable medium comprising program code instructions for carrying out the steps of the method according to claim 1 when said program code instructions are executed on a computer.
